(19) United States
(12) Patent Application Publication
(10) Pub. No.: US 2004/0095372 A1
(43) Pub. Date: May 20, 2004

(54) System and method for progressive levels of user assistance information

(75) Inventors: Richard Edmond Berry, Georgetown, TX (US); Mark Henry Dellenbaugh, Cedar Park, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/294,250

(22) Filed: Nov. 14, 2002

(51) Int. Cl. G09G 5/00

(52) U.S. Cl. 345/713; 345/790

(57) ABSTRACT

A system and method for progressive levels of user assistance information is presented. A user positions a selector icon over an object which invokes processing to seamlessly display a top level help window corresponding the object. The top level help window includes a title of the corresponding object. The user selects the top level help window to invoke processing to seamlessly display an intermediate level help window. The intermediate level help window includes a description of the corresponding object as well as detail level graphical controls. The user selects one of the detail level graphical controls to invoke processing to seamlessly display a detail level help window. The detail level help window may include instructions regarding the use of the corresponding icon's function or the detail level help window may include text regarding why a user uses the particular icon's function. The user seamlessly navigates through various help windows until the user sufficiently understands the particular icon's function.

### BACKGROUND OF THE INVENTION

1. Technical Field

The present invention relates in general to a system and method for providing progressive levels of user assistance information. More particularly, the present invention relates to a system and method for providing a particular help level and an option to select progressive help levels based upon a user's preference.

2. Description of the Related Art

Software application programs have grown in conjunction with the growth of computer systems, both in the household as well as in the workplace. At one time, software applications were tailored to large business applications, such as word processing and spreadsheet applications. However, overwhelming amounts of households and small businesses have computer systems today, and software developers produce software applications to meet the needs of homeowners and small businesses.

In addition, software applications are becoming more feature rich and complex. For example, a user is now able to include pictures, graphics, tables, and a host of other images into a document. Many users do not read software application manuals before attempting to use a software application. Instead, a user typically relies on the intuitive nature of the application itself. However, a challenge found with many software applications is that the applications are not intuitive enough, despite the developer's efforts, and a user spends unproductive time trying to understand a particular function within the software application before he consults a user manual.

Many applications include a user interface with icons that a user may select to perform a particular function (i.e. open a file). When a user positions a pointer over a particular icon, a “tool tip”, or title window may appear which gives the user an indication of what happens if a user selects the corresponding icon (i.e. “Opens a file”). A challenge found, however, is that a user may require more information in addition to what the title window provides in order to effectively use the icon's function. If the user requires more detail regarding the operation of a particular function, the user opens a separate help menu and performs a new search to identify a level of help corresponding to his particular requirement. A challenge found with using a separate help menu is that terminology in the help menu may not be consistent with terminology in the user interface which may frustrate the user.

What is needed, therefore, is a system and method that provides a user with seamless help information levels such that the help information levels meet the user's help level requirements wherein the user is not required to access a separate help component to retrieve the information.

### SUMMARY

It has been discovered that the aforementioned challenges are resolved by providing a user with progressive help levels corresponding to a particular function which allows the user to seamlessly access help levels without accessing a separate help menu. A user accesses a particular help level window by using a pointing device to select one or more graphical controls. Four individual help windows are organized in a three-tier hierarchical structure. The four help windows are a title window, a description window, an instruction window, and a concept window. The three hierarchical levels are a top level, an intermediate level, and a detail level.

The top level help window, such as the title window, is the first window that is displayed when a user uses a pointing device to position a selector icon over an object, such as an icon. The title window includes a title of the corresponding icon, such as “Open Folder”. If the user wishes to view a progressive level of help corresponding to the title window, the user uses the pointing device (i.e. mouse) to select the title window (i.e. mouse click). The title window is an intermediate level graphical control which, when selected, seamlessly displays an intermediate level help window, such as the description window.

The intermediate level help window includes text which describes a corresponding object's function. Using the example described above, the description window may include the text “Allows you to open a folder in which you can save and retrieve selected documents” to describe the “Open Folder” icon.

The intermediate level help window includes detail level graphical controls that the user selects in order to view a progressive level of help corresponding to the intermediate level help window. Selecting a detail level graphical control invokes processing to seamlessly display a detail level help window, such as the instruction window or the concept window.

The instruction window includes instructions as how to use a corresponding object's function. While viewing the instruction window, the user may navigate to the concept window to view concepts corresponding to a particular object. When the user is finished viewing the instruction window, the user selects a close control, such as a close button, to close the instruction window.

The concept window includes text which provides information as to why a user may wish to use a corresponding object's function. While viewing the concept window, the user may view related by selecting a hypertext link. When the user is finished viewing the concept window, the user selects a close control, such as a close button, to close the concept window.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a hierarchy structure of various help level windows;

FIG. 2A is a user interface window showing a selector icon positioned over an object wherein processing displays a top level help window;

FIG. 2B is an intermediate level help window with detail level graphical controls;

FIG. 3A is a detail level help window showing a user selecting a different detail level help window by selecting a different detail level graphical control using a selector icon;

FIG. 3B is a detail level help window showing concepts corresponding to an object;

FIG. 4 is a high level flow chart showing steps taken in displaying progressive help windows;

FIG. 5 is a flowchart showing steps taken in displaying a description window and processing a user's selection;

FIG. 6 is a flowchart showing steps taken in displaying an instruction window and processing a user's selection;

FIG. 7 is a flowchart showing steps taken in displaying a concept window and processing a user's selection; and

FIG. 8 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

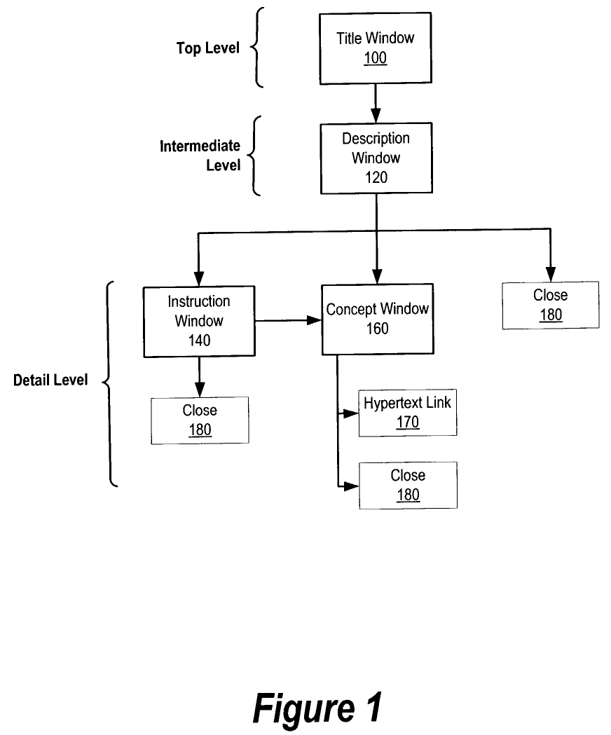

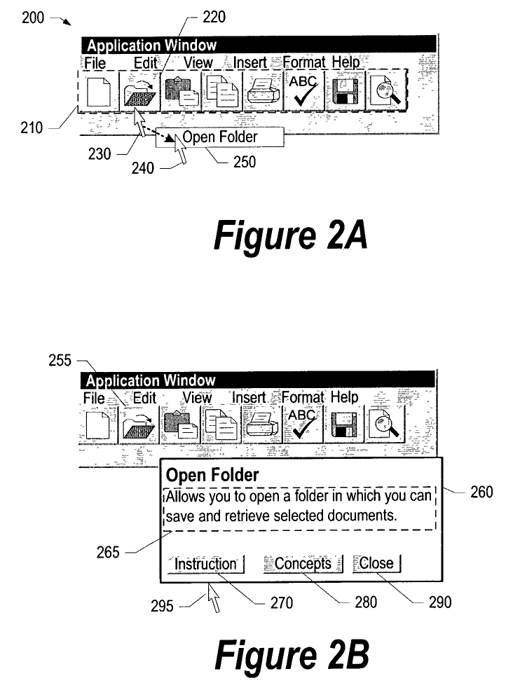

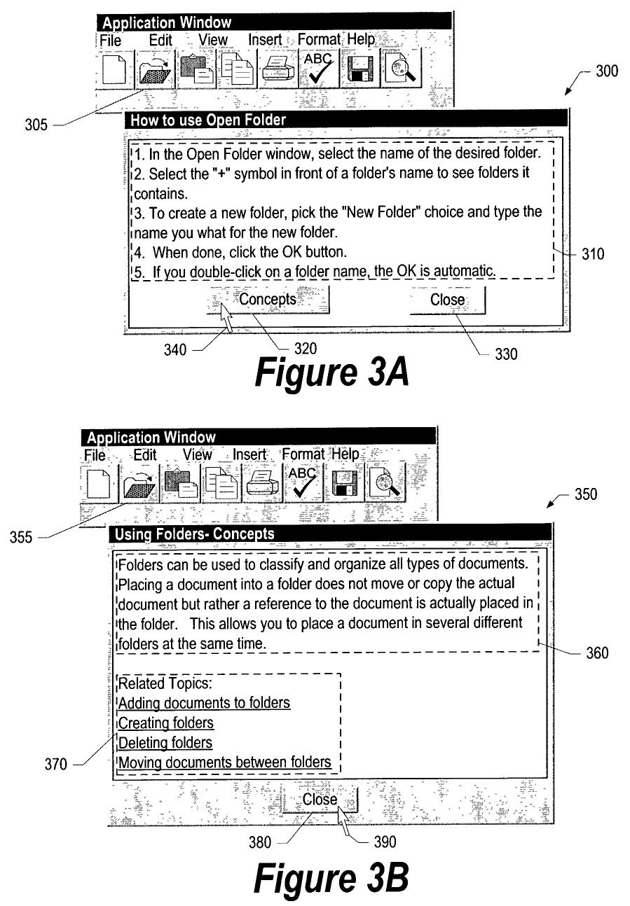

FIG. 1 is a diagram showing a hierarchy structure of various help level windows. A user may access a particular help level window by using a selector icon to select one or more graphical controls (see FIGS. 2A, 2B, 3A, 3B, and corresponding text for further details regarding graphical control selection). FIG. 1 shows a hierarchy structure of four individual help windows that are organized in three hierarchical levels. The four help windows are title window 100, description window 120, instruction window 140, and concept window 160. The three hierarchical levels are a top level, an intermediate level, and a detail level. A top level help window, such as title window 100, is the first window that processing displays when a user uses a pointing device (i.e. mouse) to position a selector icon over an object, such as an icon. Title window 100 includes a title of the corresponding icon, such as “Open Folder”.

If the user wishes to view a progressive level of help corresponding to title window 100, the user selects title window 100 using the pointing device (i.e. mouse click). Title window 100 is an intermediate level graphical control which, when selected, invokes processing to display an intermediate level help window, such as description window 120. The intermediate level help window includes text which describes a corresponding object's function. Using the example described above, description window 120 may include the text “Allows you to open a folder in which you can save and retrieve selected documents” to describe the “Open Folder” icon.

The intermediate level help window includes detail level graphical controls that the user selects if the user wishes to view a progressive level of help corresponding to the intermediate level help window (see FIGS. 2B, 3A and corresponding text for further details regarding detail level graphical controls). Selecting a detail level graphical control invokes processing to seamlessly display a detail level help window, such as instruction window 140 or concept window 160. Instruction window 140 includes instructions as how to use a corresponding object's function. Concept window 160 includes text which provides information as to why a user may wish to use a corresponding object's function. A user may close description window 120 by selecting a close control, such as close 180 (see FIG. 2B and corresponding text for further details regarding description window navigation.

While viewing instruction window 140, the user may navigate to concept window 160 to view concepts corresponding to a particular object. When the user is finished viewing instruction window 140, the user selects a close control, such as close 180 to close instruction window 140 (see FIG. 3A and corresponding text for further details regarding instruction window navigation).

While viewing concept window 160, the user may seamlessly view topics related to concept window 160 by selecting a hypertext link, such as hypertext link 170. When the user is finished viewing concept window 160, the user selects a close control, such as close 180, to close concept window 160 (see FIG. 3B and corresponding text for further details regarding concept window navigation and hypertext links).

FIG. 2A is a user interface window showing a user selecting an object. User interface window 200 includes toolbar 210 that includes various objects, such as icons, wherein each object corresponds to a particular function. A user may infrequently use a particular object's function and may require help to understand the object's function. FIG. 2A shows a user positioning selector icon 230 over “open folder” object 220 using a pointing device (i.e. mouse). Processing detects selector icon 230 positioned over object 220 (i.e. a “mouseover” event), and displays title window 250.

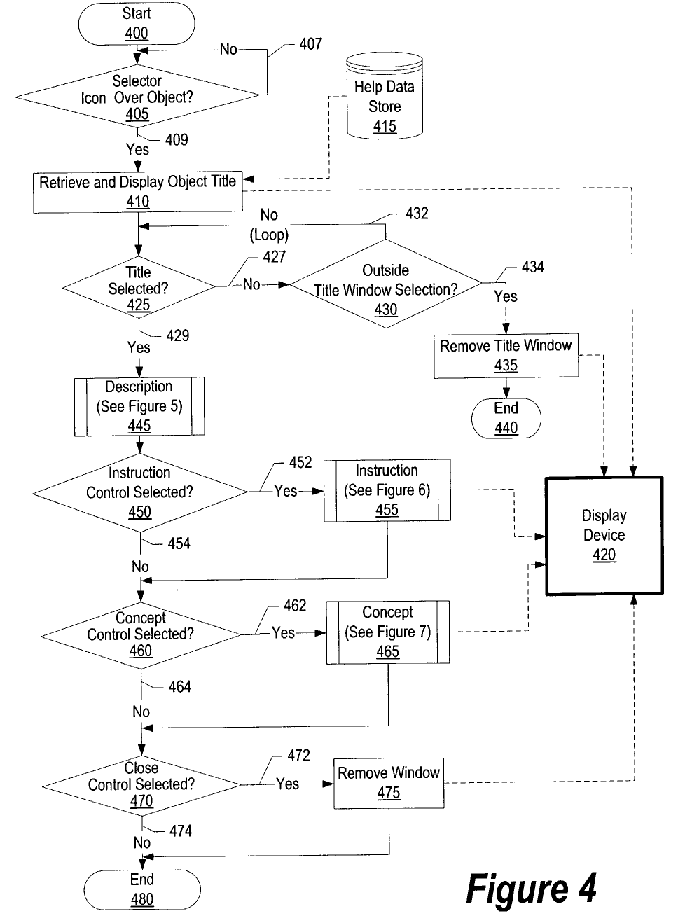

Title window 250 is a top level help window that corresponds to object 220 (see FIG. 4 and corresponding text for further details regarding displaying a title window). In one embodiment, processing may wait for the user to keep selector icon 230 over object 220 for a particular time, such as one second, before displaying title window 250. Title window 250 shows that object 220's corresponding title is “Open Folder”. The top level help window, such as title window 250, may provide enough assistance for the user to use the corresponding object, in which case the user removes title window 250 by moving selector icon 230 using his pointing device to an outside window position (i.e. outside title window 250).

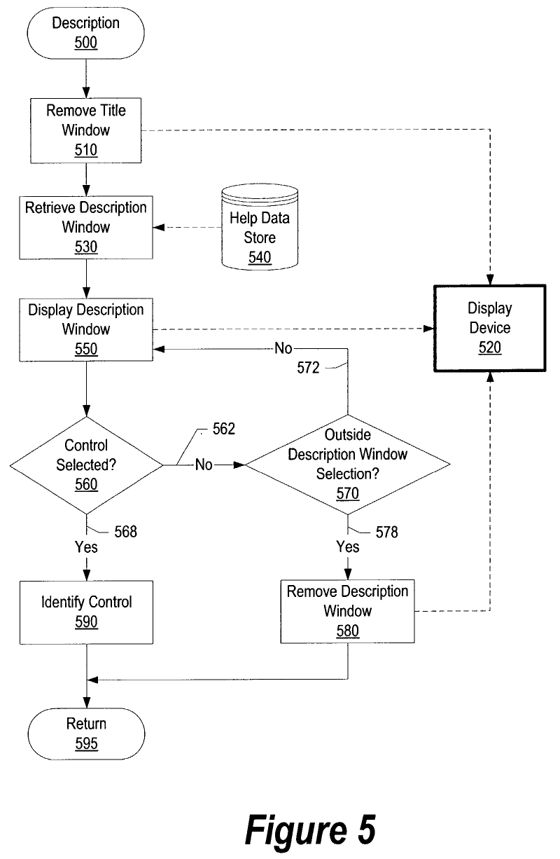

On the other hand, if the user desires a progressive help level corresponding to title window 250, the user moves the selector icon using his pointing device over title window 250, such as selector icon 240, and selects title window 250. The user selects title window 250 by providing a selection event, such as clicking one of the mouse buttons. In one embodiment, title window 250 in itself may be an intermediate level graphical control whereby selecting title window 250 invokes processing to seamlessly display an intermediate level help window. In another embodiment, title window 250 may include a specific graphical control, such as a “command button”, that a user selects to view an intermediate level help window (see FIGS. 2B, 5, and corresponding text for further details regarding intermediate level help level windows).

FIG. 2B is an intermediate level help window, such as description window 260, showing a description of a corresponding object, such as object 255. The user previously selected an intermediate level graphical control from a top level help window which invoked processing to seamlessly display the intermediate level help window, such as description window 260 (see FIG. 2A and corresponding text for further details regarding intermediate level graphical control selection).

Description window 260 includes text 265 which describes a corresponding object's function, such as object 255. The example in FIG. 2B shows that text 265 informs the user that object 255 “Allows you to open a folder in which you can save and retrieve selected documents”. The intermediate level help window, such as description window 260, may provide enough assistance for the user to use the corresponding object, in which case the user removes description window 250 by selecting close command button 290 using a pointing device (e.g. a mouse) to position selection icon 295 over close command button 290, and selecting the close function using the pointing device (e.g. clicking one of the mouse buttons). A command button is a graphical control that can be used to invoke a process. As will be appreciated by those skilled in the art, other graphical controls, such as hyperlinks, radio buttons, check boxes, frames, windows, and the like could be used in place of a command button. The user may also position selector icon 295 outside description window 260 using his pointing device to close the window (see FIG. 5 and corresponding text for further details regarding description window closing steps).

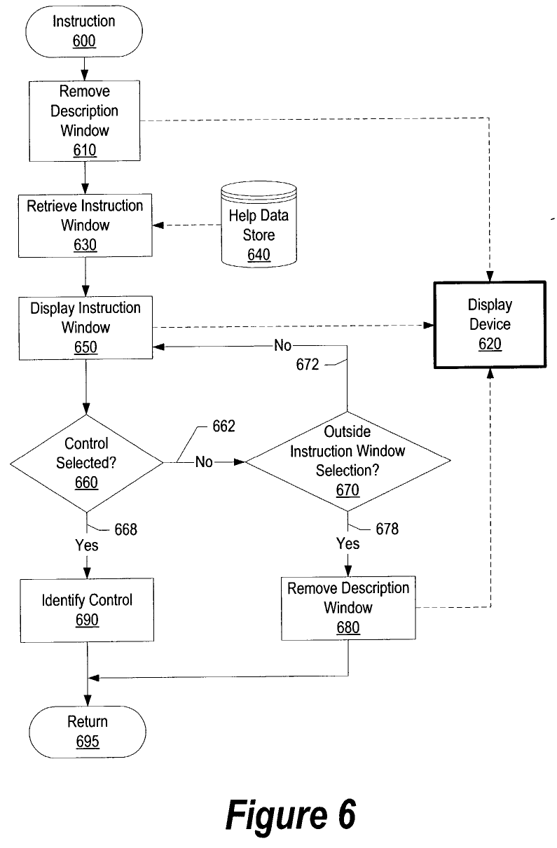

On the other hand, if the user requires a progressive help level corresponding to “open folder” object 255, the user uses the pointing device to position selector icon 295 over a detail level graphical control, such as instruction command button 270 or concepts command button 280, and selects one of the detail level graphical controls using the pointing device (e.g. clicking one of the mouse buttons). If the user selects instruction command button 270, processing seamlessly displays a detail level help window that provides instructions regarding the operation of the corresponding object (see FIGS. 3A, 6, and corresponding text for further details regarding instruction windows). In this example, instructions would be provided to the user of the “open folder” function. If the user selects concepts command button 280, processing seamlessly displays a detail level help window that provides information as to why a user may wish to use a corresponding object's function (see FIG. 3B, 7, and corresponding text for further details regarding concept windows). In this example, the concepts relating to the “open folder” function would be provided if the user selected concepts command button 280. The example in FIG. 2B shows the user selecting instruction command button 270 using selector icon 295 to view a corresponding instruction window.

FIG. 3A is a detail level help window, such as instruction window 300, showing instructions corresponding to an object, such as “open folder” object 305. Window 300 is displayed in response to the user previously selecting a detail level graphical control. As a result, processing seamlessly displayed instruction window 300 (see FIG. 2B and corresponding text for further details regarding selecting a instruction window).

Instruction window 300 includes text 310 that instructs a user how to user a particular object's function, such as “open folder” object 305. The example shown in FIG. 3A informs the user how to open a folder once the user selects “open folder” object 305. The detail level help window, such as instruction window 300, may provide enough assistance for the user to use the corresponding object, in which case the user selects close command button 330 using a pointing device (e.g. mouse) by positioning selector icon 340 over close command button 330 and selecting (i.e. mouse click) close command button 330 which closes instruction window 300.

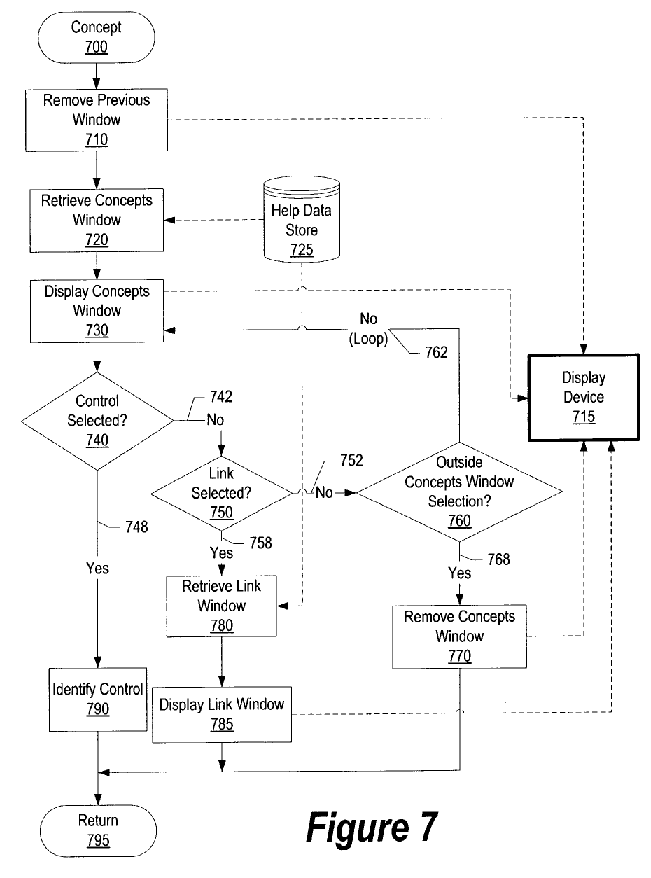

On the other hand, if the user wishes to understand the concept of using the object, the user uses the pointing device to position selector icon 340 over concepts command button 320 and selects the concepts function using the pointing device (e.g. clicking one of the mouse buttons). In turn, processing seamlessly displays a concept window that provides information as to why a user may wish to use a corresponding object's function, such as “open folder” object 305 (see FIGS. 3B, 7, and corresponding text for further details regarding concept windows). The example in FIG. 3A shows the user selecting concepts command button 320 to view a corresponding concept window.

In one embodiment, text 310 may include one or more hypertext links for a user to select. In this embodiment, the hypertext links correspond to subjects related to text 310. Using the example described above, a hypertext link may be “Deleting Folders”. When a user selects a hypertext link, processing retrieves help information corresponding to the hypertext link, and seamlessly displays the corresponding help information in a hypertext link window.

FIG. 3B is a detail level help window, such as concept window 350, showing concepts corresponding to an object, such as “open folder” object 355. Window 350 is displayed in response to selecting a detail level graphical control which invoked processing to display concept window 350 (see FIGS. 2B, 3A and corresponding text for further details regarding selecting a concept window).

Concept window 350 includes text 360 which provides information as to why a user may wish to use a corresponding object's function, such as “open folder” object 305. The example shown in FIG. 3B shows that text 360 informs the user that folders may be used to classify and organize documents. Concept window 350 also includes hypertext links 370. A user may use a pointing device to select one of the hypertext links included in hypertext links 370 to seamlessly view related to concept window 350. When a user selects a hypertext link, processing retrieves help information corresponding to the hypertext link, and seamlessly displays the corresponding help information in a hypertext link window.

In one embodiment, processing retrieves and displays an intermediate level help window corresponding to the selected hypertext link, and the user may select progressive levels of help corresponding to the selected hypertext link (see FIG. 2B and corresponding text for further details regarding intermediate level help windows). In this manner, many tree-like branches of help information can be seamlessly provided to the user.

The user may remove concept window 350 by using his pointing device to position selector icon 390 over close command button 380 and selecting close command button (i.e. mouse click). In turn, processing closes concept window 350.

FIG. 4 is a high level flow chart showing steps taken in displaying progressive help windows to a user. Processing monitors a user's movements of a selector icon. In one embodiment, the operating system creates an event, such as a “mouseover” event, when the user positions the selector icon over a graphical object. For example, the selector icon may be a pointer icon, or other icon types that the user may move (i.e. with a mouse) to select objects on a computer screen. An object may be an icon that represents a particular function, such as a picture of a folder to represent an “Open Folder” function.

Processing commences at 400, whereupon a determination is made as to whether the selector icon is positioned over an object (decision 405). If the selector icon is not positioned over a particular object, decision 405 branches to “No” branch 407 whereupon processing loops back to monitor the selector icon's movement. This looping continues until the selector icon is positioned over an object, at which point decision 405 branches to “Yes” branch 409. In one embodiment, processing may have a timeout feature wherein processing continues to branch to “No” branch 407 until the selector icon remains over a particular object for a specified time period, such as one second.

Processing retrieves a title window from help data store 415 and displays the title window on display device 420 at step 410. The title window corresponds to the object where the selector icon is positioned and includes a title of the object. Display device 420 may be a display capable of displaying user interface windows, such as a computer monitor. Using the example described above, the title window may include the words “Open Folder”. Help data store 415 may be stored on a non-volatile storage area, such as a computer hard drive. A determination is made as to whether the user wishes to view a progressive level of help by selecting the title window using the selector icon (decision 425). The user may select the title window by placing the selector icon over the title window, and selecting the title window, such as depressing a selection button on his mouse.

If the user has not selected the title window, decision 425 branches to “No” branch 427 whereupon a determination is made as to whether the user selected a position on display device 420 that is outside of the title window using his pointing device (decision 430). Using the example described above, the user may position the selector icon outside the title window. In this example, processing may wait for the user to select an outside window position, such as with a mouse button, or processing may determine that the user chooses to have the title window removed when the user keeps the selector icon outside the title window for a particular period of time, such as one second.

If the user has not moved the selector icon outside the window, decision 430 branches to “No” branch 432 which loops back to monitor the user's selections. On the other hand, if the user moved the selector icon using his pointing device outside the window, decision 430 branches to “Yes” branch 434 whereupon processing removes the title window from display device 420 (step 435) and processing ends at 440.

If the user selects a position within the title window using the selector icon, decision 425 branches to “Yes” branch 429 whereupon processing displays a description window on display device 420 (pre-defined process block 445, see FIG. 5 and corresponding text for further details). Using the example described above, the description window includes text that describes the “Open Folder” function.

Processing returns from description window displaying steps when the user selects a position on display device 420 using the selector icon. A determination is made as to whether the user selected a detail level graphical control corresponding to an instruction window (decision 450). If the user selected an instruction control, decision 450 branches to “Yes” branch 452 whereupon processing displays an instruction window on display device 420 (pre-defined process block 455, see FIG. 6 and corresponding text for further details). Using the example described above, the instruction window includes instructions that describe how to open a folder. Processing returns from instruction window displaying steps when the user selects a position on display device 420 using the selector icon.

On the other hand, if the user did not select the instruction control, decision 450 branches to “No” branch 454. A determination is made as to whether the user selected a detail level graphical control corresponding to a concept window in either the description window or the instruction window (decision 460). If the user selected a concept control in either the description window or the instruction window, decision 460 branches to “Yes” branch 462 whereupon processing displays a concept window on display device 420 (pre-defined process block 465, see FIG. 7 and corresponding text for further details). Using the example described above, the concept window includes text that describes how folders may be used. Processing returns from concept window displaying steps when the user selects a position on display device 420 using the selector icon. On the other hand, if the user did not select a concept control, decision 460 branches to “No” branch 464.

A determination is made as to whether the user selected a close control included in the description window, the instruction window, or the concept window (decision 470). If the user selected the close control in one of the windows, decision 470 branches to “Yes” branch 472 whereupon processing closes the corresponding window on display device 420 (step 475). On the other hand, if the user did not select the close control, decision 470 branches to “No” branch 474. Processing ends at 480.

FIG. 5 is a flowchart showing steps taken in displaying a description window and processing a user's selection. Description window processing commences at 500, whereupon processing removes a title window corresponding to the object from display device 520 at step 510. The title window was previously displayed on display device 520 when the user positioned a selector icon over the corresponding object (see FIG. 4 and corresponding text for further details regarding title displaying steps).

Processing retrieves the description window corresponding to the object from help data store 540 a step 530. For example, the user may have selected an object that corresponds to a “Print Page” function and the description window includes text that describes the “Print Page” function. The description window includes detail level graphical controls (i.e. buttons) that allow a user to access progressive levels of help. The description window also includes a close control which, when selected, invokes processing to close the description window (see FIG. 2B and corresponding text for further details regarding description windows). Processing seamlessly displays the description window on display device 520 at step 550.

A determination is made as to whether the user selects one of the controls included in the description window (decision 560). If the user has not selected one of the controls included in the description window, decision 560 branches to “No” branch 562 whereupon a determination is made as to whether the user selected a position on display device 520 that is outside of the description window using his pointing device (decision 570). For example, the user may receive a sufficient amount of information in the description window and wish to close the description window by positioning the selector icon outside the description window and “clicking” his mouse. If the user has not selected a position outside the description window, decision 570 branches to “No” branch 572 which loops back to continue to monitor the user's selections. On the other hand, if the user selects an outside window position, decision 570 branches to “Yes” branch 578 whereupon processing closes the description window on display device 520 at step 580.

However, if the user selects one of the controls located in the description window using the selector icon, decision 560 branches to “Yes” branch 568 whereupon processing identifies the selected control at step 590. For example, processing may identify that the user selected a graphical control corresponding to a “instruction” window. Processing returns at 595.

FIG. 6 is a flowchart showing steps taken in displaying an instruction window and processing a user's selection. Instruction window processing commences at 600, whereupon processing removes a description window corresponding to the object from display device 620 at step 610. The description window was previously displayed on display device 620 when the user selected a title window corresponding to the object (see FIG. 5 and corresponding text for further details regarding description window displaying steps).

Processing retrieves the instruction window corresponding to the object from help data store 640 a step 630. For example, the user may have selected an object that corresponds to a “Print Page” function and the instruction window includes text that describes how to print a page. The instruction window includes detail level graphical controls (i.e. buttons) that allow a user to access progressive levels of help. The instruction window also includes a close control which, when selected, invokes processing to close the instruction window (see FIG. 3A and corresponding text for further details regarding instruction windows). Processing seamlessly displays the instruction window on display device 620 at step 650.

A determination is made as to whether the user selects one of the controls included in the instruction window (decision 660). If the user has not selected one of the controls included in the instruction window, decision 660 branches to “No” branch 662 whereupon a determination is made as to whether the user selected an position on display device 620 that is outside of the instruction window using his pointing device (decision 670). For example, the user may receive a sufficient amount of information in the instruction window and wish to close the instruction window by positioning the selector icon outside the instruction window and “clicking” his mouse. If the user has not selected a position outside the instruction window, decision 670 branches to “No” branch 672 which loops back to continue to monitor the user's selections. On the other hand, if the user selects an outside window position, decision 670 branches to “Yes” branch 678 whereupon processing closes the instruction window on display device 620 at step 680.

However, if the user selects one of the controls located in the instruction window using the selector icon, decision 660 branches to “Yes” branch 668 whereupon processing identifies the selected control at step 690. For example, processing may identify that the user selected a graphical control corresponding to a “concept” window (see FIG. 3A and corresponding text for further details regarding concept window selection). Processing returns at 695.

FIG. 7 is a flowchart showing steps taken in displaying a concept window and processing a user's selection. Concept window processing commences at 700, whereupon processing removes a previous window corresponding to the object from display device 715 at step 710. The previous window may be a description window or an instruction window in which the user was viewing (see FIGS. 2B, 3A, and corresponding text for further details regarding description windows and instruction windows).

Processing retrieves the concept window corresponding to the object from help data store 725 a step 720. For example, the user may have selected an object that corresponds to an “Open Folder” function and the concept window includes text that describes why a user may use a folder (see FIG. 3B and corresponding text for further details regarding concept windows). Processing seamlessly displays the concept window on display device 715 at step 730.

A determination is made as to whether the user selects a control included in the concept window (decision 740). In one embodiment, the concept window may include a close control which corresponds to closing the concept window. In another embodiment, the concept window may also include graphical controls to navigate to other help windows, such as an instruction window. If the user has not selected a control included in the concept window, decision 740 branches to “No” branch 742 whereupon a determination is made as to whether the user selected a hypertext link included in the concept window (decision 750). A hypertext link corresponds to a topic related to the concept window. For example, if the concept window corresponded to an “Open Folder” function, a hypertext link may be “Adding documents to folders” (see FIG. 3B and corresponding text for further details regarding hypertext links. If the user has not selected a hypertext link included in the concept window, decision 750 branches to “No” branch 752 whereupon a determination is made as to whether the user selected a position outside of the concept window using his pointing device (decision 760). For example, the user may receive a sufficient amount of information in the concept window and wish to close the concept window by positioning the selector icon outside the concept window and “clicking” his mouse. If the user has not selected an outside window position, decision 760 branches to “No” branch 762 which loops back to continue to monitor the user's selections. On the other hand, if the user selected an outside window position, decision 760 branches to “Yes” branch 768, whereupon processing closes the concept window on display device 715 at step 770.

However, if the user selects one of the hypertext links included in the concept window, decision 750 branches to “Yes” branch 758 whereupon a link window corresponding to the selected hypertext link is retrieved form help data store 725 (step 780). For example, the link window may be a description window of a function corresponding to the selected link and the description window includes graphical controls for the user to access progressive help levels. Processing seamlessly displays the link window on display device 715 at step 785.

However, if the user selects a control located in the concept window using the selector icon, decision 740 branches to “Yes” branch 778 whereupon the selected control is identified at step 790. Processing returns at 795.

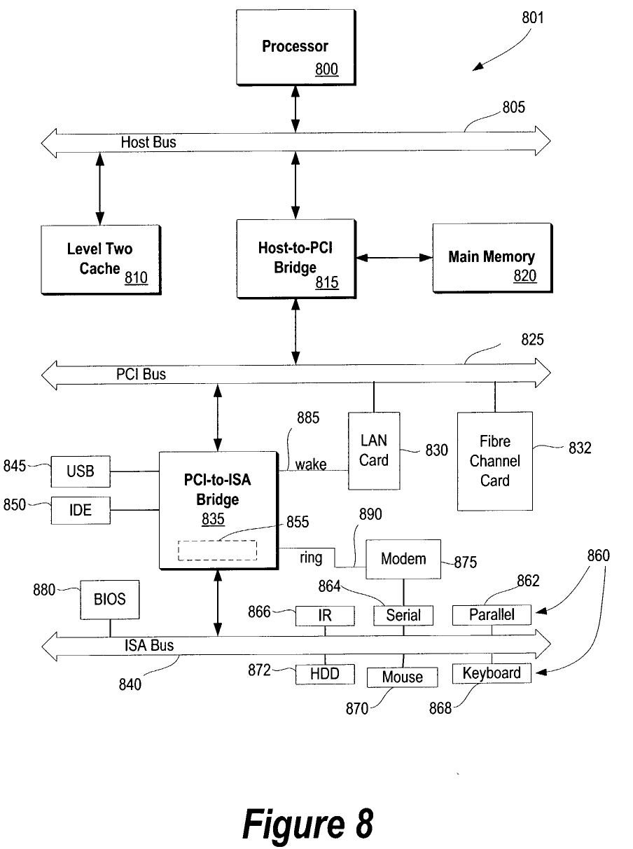

FIG. 8 illustrates information handling system 801 which is a simplified example of a computer system capable of performing the invention described herein. Computer system 801 includes processor 800 which is coupled to host bus 805. A level two (L2) cache memory 810 is also coupled to the host bus 805. Host-to-PCI bridge 815 is coupled to main memory 820, includes cache memory and main memory control functions, and provides bus control to handle transfers among PCI bus 825, processor 800, L2 cache 810, main memory 820, and host bus 805. PCI bus 825 provides an interface for a variety of devices including, for example, LAN card 830. PCI-to-ISA bridge 835 provides bus control to handle transfers between PCI bus 825 and ISA bus 840, universal serial bus (USB) functionality 845, IDE device functionality 850, power management functionality 855, and can include other functional elements not shown, such as a real-time clock (RTC), DMA control, interrupt support, and system management bus support. Peripheral devices and input/output (I/O) devices can be attached to various interfaces 860 (e.g., parallel interface 862, serial interface 864, infrared (IR) interface 866, keyboard interface 868, mouse interface 870, and fixed disk (HDD) 872) coupled to ISA bus 840. Alternatively, many I/O devices can be accommodated by a super I/O controller (not shown) attached to ISA bus 840.

BIOS 880 is coupled to ISA bus 840, and incorporates the necessary processor executable code for a variety of low-level system functions and system boot functions. BIOS 880 can be stored in any computer readable medium, including magnetic storage media, optical storage media, flash memory, random access memory, read only memory, and communications media conveying signals encoding the instructions (e.g., signals from a network). In order to attach computer system 801 to another computer system to copy files over a network, LAN card 830 is coupled to PCI bus 825 and to PCI-to-ISA bridge 835. Similarly, to connect computer system 801 to an ISP to connect to the Internet using a telephone line connection, modem 875 is connected to serial port 864 and PCI-to-ISA Bridge 835.

While the computer system described in FIG. 8 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of displaying help levels on a computer system, said method comprising:
detecting a user positioning a selector icon over an object using a pointing device, wherein the object corresponds to a particular function;
displaying a top level help window in response to the detection, wherein the top level help window includes high level help text corresponding to the function and one or more intermediate level graphical controls;
receiving an intermediate selection from the user, wherein the intermediate selection corresponds to one of the intermediate level graphical controls; and
displaying an intermediate level help window in response to receiving the intermediate selection, wherein the intermediate level help window includes intermediate level help text corresponding to the function and one or more detail level graphical controls.

2. The method as described in claim 1 wherein at least one of the intermediate level graphical controls are selected from the group consisting of a command button, a hyperlink, a radio button, a check box, a frame, and a window.

3. The method as described in claim 1 wherein the at least one of the windows included in the plurality of windows is selected from the group consisting of a title window, a description window, an instruction window, and a concept window.

4. The method as described in claim 1 further comprising:
identifying a position of the selector icon being outside one of the displayed windows; and
closing the displayed window in response to the identifying.

5. The method as described in claim 1 wherein one of the windows from the plurality of windows includes one or more hypertext links, the method further comprising:
receiving a hypertext link selection, the hypertext link selection corresponding to the user selecting one of the hypertext links using the pointing device;
retrieving a hypertext description window, wherein the hypertext description window corresponds to the selected hypertext link; and
displaying the hypertext description window.

6. The method as described in claim 1 wherein the top level help window is a title window and wherein the intermediate level help window is a description window, the description window including one or more detail level graphical controls, the method further comprising:
receiving a detail selection wherein the detail selection corresponds to the user selecting one of the detail level graphical controls;
retrieving a detail level help window, wherein the detail level help window corresponds to the selected detail level graphical control; and
displaying the detail level help window.

7. The method as described in claim 1 wherein at least one of the detail level graphical controls are selected from the group consisting of a command button, a hyperlink, a radio button, a check box, a frame, a window, an exit control, and a cancel control.

8. An information handling system comprising:
one or more processors;
a pointing device controlled by the processors;
a display device accessible by the processors;
a memory accessible by the processors;
one or more nonvolatile storage devices accessible by the processors; and
a help level handling tool to perform sequential help level requests, the help level handling tool including:
means for detecting a user positioning a selector icon over an object using the pointing device, wherein the object corresponds to a particular function;
means for retrieving a top level help window from one of the nonvolatile storage devices in response to the detection;
means for displaying the top level help window on the display device, wherein the top level help window includes high level help text corresponding to the function and one or more intermediate level graphical controls;
means for receiving an intermediate selection from the user, wherein the intermediate selection corresponds to one of the intermediate level graphical controls; and
means for retrieving an intermediate level help window from one of the nonvolatile storage devices, the intermediate level help window corresponding to the intermediate selection;
means for displaying the intermediate level help window on the display in response to the intermediate selection, the intermediate level help window including intermediate level help text corresponding to the function and one or more detail level graphical controls.

9. The information handling system as described in claim 8 wherein at least one of the intermediate level graphical controls are selected from the group consisting of a command button, a hyperlink, a radio button, a check box, a frame, and a window.

10. The information handling system as described in claim 8 wherein the at least one of the windows included in the plurality of windows is selected from the group consisting of a title window, a description window, an instruction window, and a concept window.

11. The information handling system as described in claim 8 further comprising:
means for identifying a position of the selector icon being outside one of the displayed windows on the display device; and means for closing one of the displayed windows on the display device in response to the identifying.

12. The information handling system as described in claim 8 wherein one of the windows from the plurality of windows includes one or more hypertext links, the method further comprising:
means for receiving a hypertext link selection from the pointing device, the hypertext link selection corresponding to the user selecting one of the hypertext links using the pointing device;
means for retrieving a hypertext description window from one of the nonvolatile storage devices, wherein the hypertext description window corresponds to the selected hypertext link; and
means for displaying the hypertext description window on the display device.

13. The information handling system as described in claim 8 wherein the top level help window is a title window and wherein the intermediate level help window is a description window, the description window including one or more detail level graphical controls, the method further comprising:
means for receiving a detail selection from the pointing device wherein the detail selection corresponds to the user selecting one of the detail level graphical controls on the display device;
means for retrieving a detail level help window from one of the nonvolatile storage devices, wherein the detail level help window corresponds to the selected detail level graphical control; and
means for displaying the detail level help window on the display device.

14. A computer program product stored on a computer operable media for performing sequential help level requests, said computer program product comprising:
means for detecting a user positioning a selector icon over an object using a pointing device, wherein the object corresponds to a particular function;
means for displaying a top level help window in response to the detection, wherein the top level help window includes high level help text corresponding to the function and one or more intermediate level graphical controls;
means for receiving an intermediate selection from the user, wherein the intermediate selection corresponds to one of the intermediate level graphical controls; and
means for displaying an intermediate level help window in response to receiving the intermediate selection, wherein the intermediate level help window includes intermediate level help text corresponding to the function and one or more detail level graphical controls.

15. The computer program product as described in claim 14 wherein at least one of the intermediate level graphical controls are selected from the group consisting of a command button, a hyperlink, a radio button, a check box, a frame, and a window.

16. The computer program product as described in claim 14 wherein the at least one of the windows included in the plurality of windows is selected from the group consisting of a title window, a description window, an instruction window, and a concept window.

17. The computer program product as described in claim 14 further comprising:
means for identifying a position of the selector icon being outside one of the displayed windows; and
means for closing the displayed window in response to the identifying.

18. The computer program product as described in claim 14 wherein one of the windows from the plurality of windows includes one or more hypertext links, the method further comprising:
means for receiving a hypertext link selection, the hypertext link selection corresponding to the user selecting one of the hypertext links using the pointing device;
means for retrieving a hypertext description window, wherein the hypertext description window corresponds to the selected hypertext link; and
means for displaying the hypertext description window.

19. The computer program product as described in claim 14 wherein the top level help window is a title window and wherein the intermediate level help window is a description window, the description window including one or more detail level graphical controls, the method further comprising:
means for receiving a detail selection wherein the detail selection corresponds to the user selecting one of the detail level graphical controls;
means for retrieving a detail level help window, wherein the detail level help window corresponds to the selected detail level graphical control; and
means for displaying the detail level help window.

20. The computer program product as described in claim 14 wherein at least one of the detail level graphical controls are selected from the group consisting of a command button, a hyperlink, a radio button, a check box, a frame, a window, an exit control, and a cancel control.
